(19) United States
(12) Patent Application Publication
(10) Pub. No.: US 2007/0085934 A1
(43) Pub. Date: Apr. 19, 2007

(54) Image output device

(75) Inventors: Toshihiro Takagi, Osaka (JP); Kosuke Kinoshita, Osaka (JP)

Correspondence Address: PILLSBURY WINTHROP SHAW PITTMAN, LLP, P.O. BOX 10500, MCLEAN, VA, 22102, US

(73) Assignee: FUNAI ELECTRIC CO., LTD., Osaka (JP)

(21) Appl. No.: 11/546,361

(22) Filed: Oct. 12, 2006

(30) Foreign Application Priority Data
Oct. 13, 2005 (JP) 2005-299030

(51) Int. Cl. H04N 5/44

(52) U.S. Cl. 348/734

(57) ABSTRACT

An image output device includes a light emission unit, a light reception unit, a decision unit, and an output unit, and outputs an image upon a display device that has a light reception surface for receiving a control signal. The light emission unit is for placement opposite the light reception surface. The light reception unit receives a control signal outputted from the remote control device. The decision unit decides whether the received control signal is a control signal for which processing should be performed by the display device, or is a control signal for which processing should be performed by the image output device. The output unit, when it has been decided by the decision unit that the received control signal is a control signal for which processing should be performed by the display device, causes the light emission unit to emit light based upon the received control signal.

### CROSS REFERENCE

This Nonprovisional application claims priority under 35 U.S.C. § 119(a) on Patent Application No. 2005-299030 filed in Japan on Oct. 13, 2005, the entire contents of which are hereby incorporated by reference.

### BACKGROUND OF THE INVENTION

The present invention relates to an image output device, such as an STB (Set Top Box) or the like, which outputs an image upon a display device, such as a television.

An STB, which is an image output device, receives broadcast programs and outputs them upon a television receiver. Furthermore, an STB receives control signals such as commands to change the channel for programs which are outputted from a remote control device of the STB, and performs control according to these control signals.

On the other hand, in the case of a television receiver as well, control signals are received from a remote control device of such a television receiver for changing the volume of its sound output and so on, and control is performed according to these control signals. Accordingly, it is necessary to utilize two individual remote control devices for actuating the STB and the television receiver, so that, from the point of view of the user, the operation becomes troublesome, and this imposes a certain burden.

Thus, as disclosed in Japanese Laid-Open Patent Publication 2003-32508, there has been proposed a structure in which an STB and a television receiver are connected together via a serial path, and control signals for both the STB and the television receiver are outputted using a single remote control device. When the user actuates the remote control device to output a control signal for the television receiver, upon receipt of this signal, the television receiver processes it internally, while, when the user actuates the remote control device to output a control signal for the STB, upon receipt of this signal, the television receiver outputs it to the STB via the serial path, and the control signal is processed internally to the STB.

Furthermore, in order to perform actuation of functions intrinsic to both of the devices in a simple and moreover unified manner using a general purpose remote control device, in Japanese Laid-Open Patent Publication 2001-224079, there is disclosed a structure with which, upon the display device, there is displayed an image of a remote control device specific to each device, and commands are actuated by selecting them upon the image, using the remote control device.

However, with the structure disclosed in the above described Japanese Laid-Open Patent Publication 2003-32508 in which the STB and the television receiver are connected together with a serial path, it is necessary to provide both the television receiver and the STB with an output unit and an input unit which are connected to the serial path, so that there is an undesirable increase in the cost. Furthermore, since, when purchasing a television receiver, it is not very often the case that the user pays any attention to purchasing a television receiver which, in the future, can be connected to an STB via a serial path, accordingly, if the receiver that he has purchased is not a television receiver of a type which includes an output unit which can be connected to a serial path, then, even if an STB which he subsequently purchases is of a type which can be connected to a serial path, still he will not be able to control this STB using the remote control device of his television receiver, and, finally, he will be obliged to use the two separately provided remote control devices which are specific for the receiver and the STB.

Moreover, with the structure disclosed in the above described Japanese Laid-Open Patent Publication 2001-224079 in which a general purpose remote control device is employed, or with a structure in which the remote control device of the STB is employed, although it is possible for the user to control both devices by using a single remote control device in this manner, it must be considered that, from the point of view of the user, he would prefer to use the original remote control device of the television receiver, which he has become used to employing habitually. Normally a television receiver is purchased before purchasing an STB, and the period of time over which the user has used the remote control device of the television receiver is longer than the time over which he has used the remote control device of the STB.

The objective of the present invention is to provide an image output device, in which both the display device and the image output device itself may be controlled with a simple structure, without any addition to the structure on the side of the display device, and using only the remote control device of the display device, thereby alleviating the burden upon the user.

### SUMMARY OF THE INVENTION

The image output device of the present invention comprises a light emission unit, a light reception unit, a decision unit, and an output unit, and outputs an image upon a display device that has a light reception surface for receiving a control signal.

The light emission unit is for placement opposite the light reception surface. The light reception unit receives a control signal outputted from the remote control device. The decision unit decides whether the received control signal is a control signal for which processing should be performed by the display device, or is a control signal for which processing should be performed by the image output device. The output unit, when it has been decided by the decision unit that the received control signal is a control signal for which processing should be performed by the display device, causes the light emission unit to emit light based upon the received control signal.

### BRIEF DESCRIPTION OF THE DRAWINGS

FIG. 1 is a figure showing the external appearance of an STB according to an embodiment of the present invention, and the external appearance of a television receiver connected to this STB;

FIG. 2 is a block diagram showing the structure of the main portion of this STB according to the embodiment of the present invention;

FIG. 3A is an explanatory figure showing a selection screen when setting the type number of a television receiver which is connected to this STB according to the embodiment of the present invention, and FIG. 3B is an explanatory figure showing the structure of a control code table in which control codes are recorded; and

FIGS. 4A and 4B are enlarged views showing the way in which an AV mouse incorporated in this STB according to the embodiment of the present invention is adhered to a television receiver.

### DETAILED DESCRIPTION OF THE INVENTION

In the following, an STB will be explained which is an embodiment of the image output device according to the present invention.

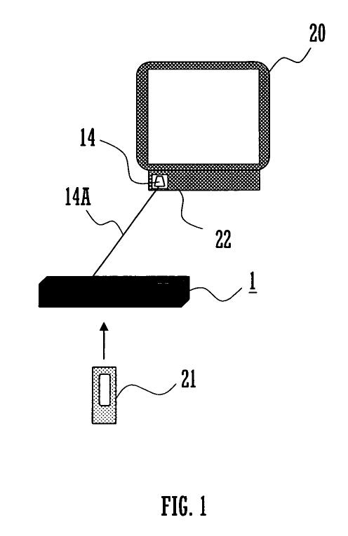

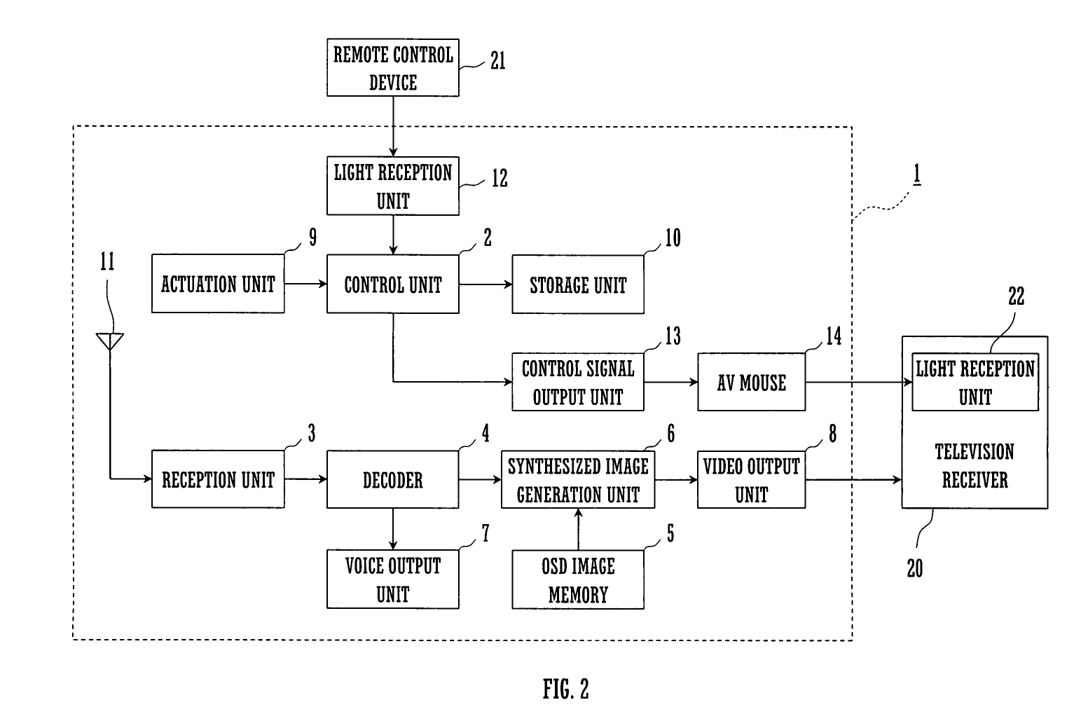

FIG. 1 is a figure showing the external appearance of this STB according to an embodiment of the present invention, and also showing the external appearance of a television receiver which is connected to this STB. And FIG. 2 is a block diagram showing the structure of the main portion of this STB according to this embodiment of the present invention.

The STB 1, spoken of as the main device, is an image output device which receives digital broadcasts of programs and outputs them upon a television receiver 20. This STB 1 comprises a control unit 2 which controls the operation of the main device, and a reception unit 3 which extracts, from the television broadcast signals received by the antenna 11, the video signal and the audio signal in a program which is broadcast upon the selected channel. Furthermore, the STB 1 comprises a decoder 4 which decodes this video signal and audio signal which have been extracted by the reception unit 3, and an OSD image memory which stores an OSD image.

Moreover, the STB 1 comprises a synthetic image generation unit 6 which generates a synthesized image by superimposing the OSD image upon the video of the program, based upon the video signal which has been decoded by the decoder 4, and a voice output unit 7 which outputs the audio signal decoded by the decoder 4. And the STB 1 also comprises a video output unit which outputs the video of the program or the synthesized image, an actuation unit for receiving input actuation, and a storage unit 10 which stores various types of setting values such as a plurality of control code tables and so on.

Furthermore, the STB 1 comprises a light reception unit 12 which receives infrared optical control signals emitted from a remote control device 21 which is provided to the television receiver 20, a control signal output unit 13 which outputs control signals, and an AV mouse 14 (corresponding to the “light emission unit” of the Claims) which emits the control signals outputted from the control signal output unit 13 as infrared optical control signals.

OSD image data is stored in the OSD image memory 5. The actuation unit 9 also receives from the user a setting for the type number of the television receiver 20. The light reception unit 12 receives the optical control signals from the remote control device 21 and transmits them to the control unit 2. The control unit 2 decides whether these transmitted control signals are ones for which the processing is to be performed by the television receiver 20, or whether they are ones which are to be processed by this STB 1; and, if it has decided that they are signals for which the processing is to be performed by the television receiver 20, then it outputs these signals to the control signal output unit 13, which then outputs them to the AV mouse 14 which emits them as infrared optical signals from its light emitting surface. On the other hand, if the control unit 2 has decided that these are control signals which are to be processed by this STB 1, then it performs processing based upon these control signals. The details thereof will be described hereinafter. It should be understood that this control signal output unit corresponds to the “output unit” of the Claims.

The AV mouse 14 is connected to the STB 1 via a cable 14A, and moreover its light emitting surface is adhered against a light reception unit 22 which is incorporated in the television receiver 20. This light reception unit 22 of the television receiver 20 thus receives the control signals which are emitted from the light emitting surface of the AV mouse 14. The television receiver 20 is controlled according to these control signals which have thus been received.

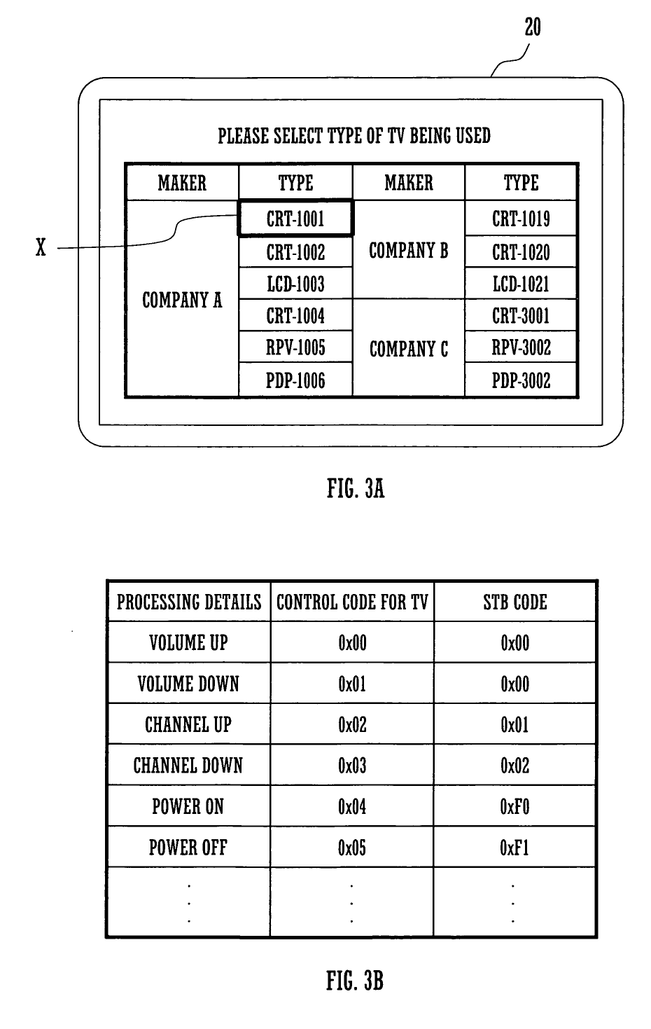

FIG. 3(A) is an explanatory figure showing a selection screen when setting the type number of the television receiver 20. And FIG. 3(B) is an explanatory figure showing the structure of a control code table.

The user selects the type number of the television receiver 20 upon the selection screen shown in FIG. 3A by using a cursor X (shown by the thick lines) which he shifts up, down, left, and right, and makes the appropriate setting. By this determination, the type number of the television receiver 20 which has thus been determined is stored in the storage unit 10.

Upon receipt of a control signal from the light reception unit 12, the control unit 2 reads out the type number of the television receiver 20 which has been set and stored in the storage unit 10, and reads out the control code table which corresponds to this type number from the plurality of control code tables. These control code tables are set up in correspondence to various television receivers manufactured by various makers. It should be understood that the control code table corresponds to the “table” of the Claims.

In this control code table, control codes and STB codes are set up in mutual correspondence, as shown in FIG. 3B. The control codes are specifications, for the television receiver 20, of the processing details shown in the left column of FIG. 3B. And the STB codes are common codes for control of the STB 1, specifying the details of processing to be performed within the STB 1. The control unit 2 converts the control codes which it has received into the STB codes by using this control code table.

Furthermore, the control unit 2 decides whether the control signal which it has received, after conversion into the STB code, is one for which processing should be performed by the television receiver 20, or one for which processing should be performed by the STB 1. In concrete terms, it decides this according to whether or not, respectively, the value of the STB code after conversion is 0×00.

For example, if the processing details of the control signal which has been received are a command to turn the sound volume up (0×00) as shown in FIG. 3(B), then, since the STB code is 0×00, it is decided that this is a control signal which should be processed by the television receiver 20. On the other hand, if the processing details of the control signal which has been received are a command to shift the channel up (0×02), then, since the STB code is 0×01, it is decided that this is a control signal which should be processed by the STB 1.

If the control unit 2 has decided that the control signal which has been received is one for which processing should be performed by the television receiver 20, then it transmits this control signal which it has received to the control signal output unit 13. Thereafter, the control signal output unit 13 emits this control signal via the AV mouse 14 in the form of an infrared optical signal. Due to this, the processing of this signal is performed by the television receiver 20. On the other hand, if the control unit 2 has decided that the control signal which has been received is one for which processing should be performed by the STB 1, then it initiates processing based upon the STB code. Accordingly, the control unit 2 corresponds to the “decision unit” of the Claims.

Due to this, it is possible to control both the television receiver 20 and the STB 1 with a simple structure, using only the remote control device of the television receiver 20, and without changing any of the structure on the side of the television receiver 20; and accordingly it is possible to alleviate the burden upon the user. Moreover, it is possible to suppress any increase in the cost, since there is no requirement for any change in the structure of the television receiver 20, and its remote control device 21 and its light reception unit 22, which are already in existence, are taken advantage of.

It should be understood that, although the decision upon whether to perform processing of the optically received control signal by the television receiver 20, or by the STB 1, has been explained as being an alternative, it would also be possible to decide to perform this processing both by the television receiver 20 and by the STB 1. For example, STB codes which mean that processing should be performed by both of them may be set as being values of 0×F0 and thereafter. As shown in FIG. 3B, when a control code for turning the power supply ON or OFF (i.e. a control code of 0×04 or 0×05) has been optically received, since the STB code is 0×F0 or 0×F1, accordingly the control unit 2 decides that this is processing which is to be performed both by the television receiver 20 and by the STB 1. And thereafter the control unit 2 transmits a control signal to the control signal output unit 13, and also starts processing based upon this STB code.

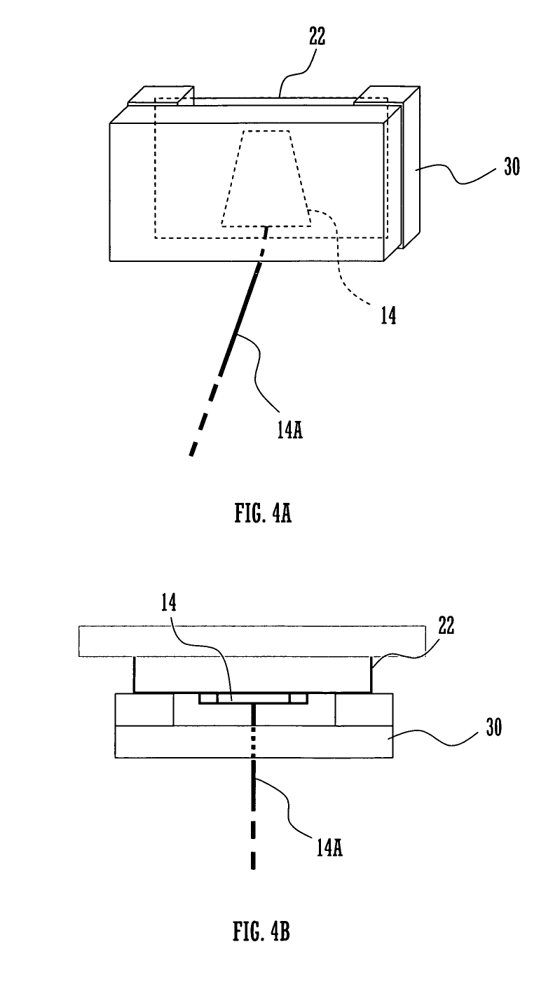

FIGS. 4A and 4B are enlarged views showing the way in which the AV mouse is adhered. FIG. 4A is an external view thereof, and FIG. 4B is a horizontal sectional view thereof. In this AV mouse 14 which is adhered to the front of the light reception unit 22 of the television receiver 20, a shield member 30 covers over its outer surface, apart from its light emitting surface. This shield member 30 is of a size to be able to cover over the entire surface of the light reception unit 22 of the television receiver 20 into which the control signals can be inputted, apart from the portion thereof which is covered over by the light emitting surface of the AV mouse 14 itself. The shield member 30 may be made of any material, provided that it is not one which is transparent to infrared rays; for example, it may be a cover which is made from black colored plastic, or it may be made from black colored vinyl tape, or as a seal member or the like. It should be understood that it is desirable to employ vinyl tape or a seal member for the shield member, since it may be simply adhered onto the light reception unit 22.

According to this structure, it is possible to prevent the light reception unit 22 of the television receiver 20 from simultaneously receiving overlapped control signals from both the remote control device 21 and the AV mouse 14. It should be understood that, although this embodiment has been explained in terms of the STB 1, the present invention could also be applied to any image output device, such as a DVD replay device or the like. Moreover, it would also be possible to apply the present invention to an STB which receives analog broadcast programs; it is not limited to one which receives digitally broadcast programs.

Finally, in the above described explanation of an embodiment of the present invention, all of the features are shown by way of example, and should not be considered as being limitative of the present invention. The scope of the present invention is not to be defined by any of the features of the embodiment described above, but only be the scope of the appended Claims. Moreover, equivalents to elements in the Claims, and variations within their legitimate and proper scope, are also to be considered as being included within the range of the present invention.

What is claimed is:

1. An image output device adapted to output an image to a display device that has a light reception surface for receiving a control signal outputted from a remote control device, the image output device comprising:
a light emission unit for placement opposite the light reception surface;
a light reception unit which receives a control signal outputted from the remote control device;
a decision unit which decides whether the received control signal is a control signal for which processing should be performed by the display device, or is a control signal for which processing should be performed by the image output device; and
an output unit connected to the light emission unit through a cable, the output unit, when it has been decided by the decision unit that the received control signal is a control signal for which processing should be performed by the display device, causing the light emission unit to emit light based upon the received control signal.

2. The image output device according to claim 1,
wherein the light emission unit includes a shield member which covers the light reception surface in such a manner that the light reception surface receives only light emitted from the light emission unit.

3. The image output device according to claim 1, further comprising:
a storage unit which stores a table in which, for each display device type number, control codes and processing details are maintained in correspondence; and
a reception means which receives setting for the type number of the display device,
wherein the decision unit reads out from the storage unit the table which corresponds to the type number of the display device which has been set, and decides whether the control signal which has been received by the light reception unit this time is a control signal processing for which processing should be performed by the display device, or is a control signal for which processing should be performed by the image output device, based upon the processing details for the control code which corresponds, in this table, to the control signal which has been received this time.
